(19) United States
(12) Patent Application Publication
(10) Pub. No.: US 2015/0215453 A1
(43) Pub. Date: Jul. 30, 2015

(54) Wireless Call Screener

(71) Applicants: Aaron Foss, Port Jefferson, NY (US); Vadim Alexander Gordin, Mineola, NY (US)

(72) Inventors: Aaron Foss, Port Jefferson, NY (US); Vadim Alexander Gordin, Mineola, NY (US)

(21) Appl. No.: 14/167,413

(22) Filed: Jan. 29, 2014

(51) Int. Cl. H04M 3/436; H04W 4/16

(52) U.S. Cl. CPC H04M 3/436; H04W 4/16

(57) ABSTRACT

Wireless call screening devices for use with cellular telephones are disclosed herein.

### CLAIM OF PRIORITY

This is the first filing made with the USPTO by the applicant regarding the present disclosure. This filing is related however to patent application Ser. No. 14/109994 filed on Dec. 18, 2013 with which it shares one inventor. The '994 application and particularly its sections dealing with call screening criteria is incorporated by reference herein in its entirety.

### BACKGROUND/FIELD

Cellular users need to often prevent unwanted phone calls. These include calls from telemarketers, political organizations, and Nigerian princes. To that end, devices are disclosed herein for the screening and prevention of unwanted phone calls.

### SUMMARY

Telephone screening devices are disclosed herein, the devices comprising; a radio transceiver, processor, and a screening criteria disposed within a substantially integral enclosure; wherein the screening device is configured to be electronically coupled to a cellular telephone via the radio transceiver such that when an incoming call is received, the call's metadata is compared by the processor to the screening criteria and if that criteria is met, the call is disconnected and therefore blocked.

According to further embodiments of the present disclosure, there is a plurality of screening criteria stored within the device.

According to further embodiments of the present disclosure, the radio transceiver is a Bluetooth transceiver.

According to further embodiments of the present disclosure, the transceiver is configured to communicate as either a headset or handsfree profile as defined by the Bluetooth specification.

According to further embodiments of the present disclosure, there are multiple screening criteria which may be selectively engaged or disengaged by the user including for instance a whitelist, do not disturb function, or partial blacklist.

According to further embodiments of the present disclosure, the enclosure has physical conductors disposed upon the surface thereof.

According to further embodiments of the present disclosure, the conductors are used to charge a battery internal to the device.

According to further embodiments of the present disclosure, the conductors are used to update the screening criteria.

According to further embodiments of the present disclosure, the physical conductors are compliant with Universal Serial Bus specification.

According to further embodiments of the present disclosure, the screening criteria are capable of being updated via the radio transceiver.

According to further embodiments of the present disclosure, the device is capable of providing visual, haptic, acoustic feedback of calls being accepted or rejected.

According to further embodiments of the present disclosure, a portion of the enclosure is configured as a capacitive input surface.

According to further embodiments of the present disclosure, there is a pushbutton disposed upon or immediately below the surface of the enclosure.

According to further embodiments of the present disclosure, there is a toggle switch disposed upon or immediately below the surface of the enclosure.

According to further embodiments of the present disclosure, there is an acoustic speaker disposed within the body of the device.

According to further embodiments of the present disclosure, upon a corresponding signal from the telephone, the speaker emits an audible tone which allows the device to be located by the user.

According to further embodiments of the present disclosure, the speaker is useable as a telephonic speakerphone.

### FIGURES

FIG. 1 shows an exemplary embodiment of a call screener having a USB A plug at a first end thereof, an aperture for a keyring at a second end thereof, and a plurality of electronic components disposed therewithin.

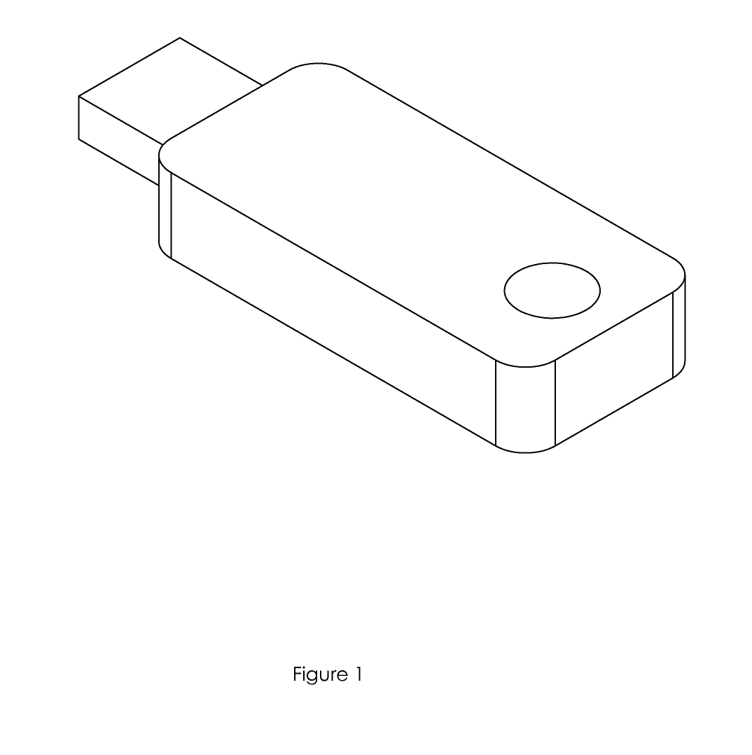

### DETAILED DESCRIPTION OF THE VARIOUS EXEMPLARY EMBODIMENTS

Various embodiments of the presently disclosed apparatus will now be described in detail.

According to a first embodiment of the present disclosure, a Bluetooth call screening device comprises a portable electronic device encased in an integral shell with a male USB A plug extending therefrom. Within the shell are disposed a Bluetooth radio transceiver, a processor unit, computer readable memory, and a battery. The device is configured to communicate with a cellular telephone via either the Handsfree profile or Headset profile as defined in the Bluetooth specification. Stored within the memory on the device is a blacklist of phone numbers which the owner of the device has chosen not to receive calls from.

When an incoming telephone call arrives at the cellular telephone, the telephone transmits the caller ID data for the call to the device. The caller ID data is then compared to the blacklist, and if there is a match, the device transmits a “hang up” command to the telephone, thereby sending the incoming call to voicemail without disturbing the user.

The blacklist may be loaded onto the device and updated in several ways, these include synchronization over the Bluetooth connection from the cellular telephone from a complementary application running on the telephone, over the physical usb connection from a host computer, over the physical usb connection from a proprietary base station, or over a Bluetooth connection from a proprietary base station.

The battery disposed within the device may be charged in several ways, these include charging via the USB connection, inductive or other wireless charging methodology, or via proprietary charging contacts disposed upon the body of the device.

According to further embodiments of the present disclosure, there is a switch disposed upon the body of the device which when actuated places the device into a “do not disturb” state, in which all incoming phone calls are rejected to voicemail with the exception of those which originate from numbers on a “whitelist” selected by the user.

According to further embodiments of the present disclosure, the male USB connector may be replaced by a connection scheme selected from the following; female USB connector, another electronic connector standard, or a proprietary set of physical conductors capable of transferring data, power, or both.

Although the device of the present disclosure has been described with reference to specific structures, features, and functionalities, these descriptions are intended as a non-limiting exemplary embodiment of an implementation of the appended claims.

What is claimed is:

1. A telephone screening device, the device comprising; a radio transceiver, processor, and a screening criteria disposed within a substantially integral enclosure; wherein the screening device is configured to be electronically coupled to a cellular telephone via the radio transceiver such that when an incoming call is received, the call's metadata is compared by the processor to the screening criteria and if that criteria is met, the call is disconnected and therefor blocked.

2. The screening device of claim 1, wherein there is a plurality of screening criteria stored within the device.

3. The screening device of claim 1, wherein the radio transceiver is a Bluetooth transceiver.

4. The screening device of claim 3, wherein the transceiver is configured to communicate as either a headset or handsfree profile as defined by the Bluetooth specification.

5. The screening device of claim 1, wherein there are multiple screening criteria which may be selectively engaged or disengaged by the user including for instance a whitelist, do not disturb function, or partial blacklist.

6. The screening device of claim 1, wherein the enclosure has physical conductors disposed upon the surface thereof

7. The screening device of claim 6, wherein the conductors are used to charge a battery internal to the device.

8. The screening device of claim 6, wherein the conductors are used to update the screening criteria.

9. The screening device of claim 1, wherein the physical conductors are compliant with Universal Serial Bus specification.

10. The screening device of claim 1, wherein the screening criteria are capable of being updated via the radio transceiver.

11. The screening device of claim 1, wherein the device is capable of providing visual, haptic, acoustic feedback of calls being accepted or rejected.

12. The screening device of claim 1, wherein a portion of the enclosure is configured as a capacitive input surface.

13. The screening device of claim 1, wherein there is a pushbutton disposed upon or immediately below the surface of the enclosure.

14. The screening device of claim 1, wherein there is a toggle switch disposed upon or immediately below the surface of the enclosure.

15. The screening device of claim 1, wherein there is an acoustic speaking disposed within the body of the device.

16. The screening device of claim 15, wherein upon a corresponding signal from the telephone, the speaker emits an audible tone which allows the device to be located by the user.

17. The screening device of claim 15, wherein the speaker is useable as a telephonic speakerphone.

18. A telephone screening device, the device comprising; a Bluetooth radio transceiver, processor, and a screening criteria comprising a telephone number blocklist disposed within a substantially integral enclosure; wherein the screening device is configured to be electronically coupled to a cellular telephone via the radio transceiver such that when an incoming call is received, the call's metadata is compared to the screening criteria and if that criteria is met, the call is disconnected and therefor blocked.
